(19) United States
(12) Patent Application Publication
(10) Pub. No.: US 2025/0130406 A1
(43) Pub. Date: Apr. 24, 2025

(54) FOLDED OPTICS INCLUDING META OPTICAL ELEMENTS

(71) Applicant: NIL Technology ApS, Kongens Lyngby (DK)

(72) Inventors: Niklas Hansson, Askim (SE); Ulrich Quaade, Bagsvaerd (DK)

(21) Appl. No.: 18/836,253

(22) PCT Filed: Feb. 8, 2023
(86) PCT No.: PCT/EP2023/053104

§ 371 Date: Aug. 6, 2024

Related U.S. Application Data
(60) Provisional application No. 63/308,244, filed on Feb. 9, 2022.

(51) Int. Cl. G02B 13/00; G02B 3/00; G02B 5/18

(52) U.S. Cl. CPC G02B 13/0055; G02B 3/00; G02B 5/1809; G02B 5/1842; G02B 2003/0093

(57) ABSTRACT

An example apparatus includes an image sensor having an optically active surface, and folded optics including at least one meta optical element (MOE). The at least one MOE is configured such that a chief ray of light impinging on, and passing through, the at least one MOE, travels along a piece-wise linear path to the optically active surface of the image sensor. NIL Technology ApS F&R Ref.: 47717-0041WO1 PCT Application

### FIELD OF THE DISCLOSURE

The present disclosure relates to folded optics including meta optical elements.

### BACKGROUND

In a camera module, the optical Z height refers to a distance from an optically active surface of an image sensor to an outermost point of a lens. This distance sometimes is referred to as the total track length (TTL). It sometimes is desirable to reduce the optical Z height or the TTL so as to achieve low-height camera modules, which can facilitate integrating the camera modules into compact electronic or other devices.

### SUMMARY

The present disclosure describes apparatus including folded optics having at least one meta optical element.

For example, in one aspect, the present disclosure describes an apparatus that includes an image sensor having an optically active surface, and folded optics including at least one meta optical element (MOE). The at least one MOE is configured such that a chief ray of light impinging on, and passing through, the at least one MOE, travels along a piece-wise linear path to the optically active surface of the image sensor.

Some implementations include one or more of the following features. For example, in some implementations, the at least one MOE is configured such that the chief ray of light travels along a path at least part of which is skewed with respect to at least one metasurface of the at least one MOE. The at least one MOE can be configured such that the chief ray of light is focused on the optically active surface of the image sensor. In some instances, the folded optics includes a plurality of MOEs configured such that the chief ray of light impinging on a first one of the MOEs passes through the plurality of MOEs and to the optically active surface of the image sensor along the piece-wise linear path. The plurality of MOEs can be configured such that the chief ray of light travels along a skewed path from a metasurface of the first one of the MOEs to the optically active surface of the image sensor. In some implementations, the folded optics includes at least three MOEs.

The at least one MOE can be configured, for example, to cause at least one diffractive order of the light to travel in a direction such that the at least one diffractive order of the light does not reach the optically active surface of the image sensor. In some instances, the apparatus includes at least one light blocking material disposed so as to block or absorb the at least one diffractive order of the light. In some implementations, the at least one MOE is configured such that only a subset of diffractive orders of the light reach the optically active surface of the image sensor.

Some implementations include at least one MOE in a first lens level and at least two MOEs in a second lens level. In some instances, the second lens level is closer to the optically active surface of the image sensor than is the first lens level. The MOEs can be arranged such that a first portion of light from the at least one MOE in the first lens level has a first subset of diffractive orders and passes through a first one of the MOEs in the second lens level, and a second portion of light from the at least one MOE in the first lens level has a second different subset of diffractive orders and passes through a second one of the MOEs in the second lens level.

Some implementations include first, second and third lens levels, wherein the MOEs are dispersed across the first, second and third lens levels, and wherein the MOEs are arranged such that the chief ray of light passes through a MOE in the first lens level, then through at least one MOE in the second lens levels, and then through at least one MOE in the third lens levels. Some implementations include at least two MOEs in the third lens level. In some instances, the third lens level is closer to the optically active surface of the image sensor than is the second lens level. The MOEs can be arranged such that a first portion of light from the at least one MOE in the second lens level has a first subset of diffractive orders and passes through a first one of the MOEs in the third lens level, and a second portion of light from the at least one MOE in the second lens level has a second different subset of diffractive orders and passes through a second one of the MOEs in the third lens level.

In some imeplementations, at least one of the MOEs is asymmetric. Each MOE can be implemented, for example, as a respective metalens. In some impleemntations, an optical axis of the at least one MOE is tilted with respect to a plane of the optically active surface of the image sensor. The folded optics can be configured such that, after passing through a metasurface of the at least one MOE, the light of an imaging diffractive order propagates through a material having a higher index of refraction relative to a material of the metasurface.

Some implementations include one or more of the following advantages. For example, some implementations can achieve a relatively small TTL, which can help facilitate providing a low-height module that can be integrated into compact electronic or other devices.

Other aspects, features and advantages will be readily apparent from the following detailed description, the accompany drawings and the claims.

### BRIEF DESCRIPTION OF THE DRAWINGS

FIG. 1 illustrates an example of a camera module including metasurfaces.

FIG. 2 illustrates another example of a camera module including metasurfaces.

FIG. 3 illustrates yet another example of a camera module including metasurfaces and light blocker or absorber.

FIG. 4 illustrates another example of a camera module including metasurfaces.

FIG. 5 illustrates a further example of a camera module.

FIG. 6 illustrates an example of a camera module including three lens levels having metasurfaces.

FIG. 7 illustrates another example of a camera module including three lens levels having metasurfaces.

FIG. 8 illustrates yet another example of a camera module including three lens levels having metasurfaces.

FIG. 9 illustrates an example of a camera module including a metasurface.

FIG. 10 illustrates another example of a camera module including a metasurface.

FIG. 11 illustrates a further example of a camera module including a metasurface.

FIG. 12 illustrates yet another example of a camera module including a metasurface.

FIG. 13 illustrates another example of a camera module including a metasurface.

### DETAILED DESCRIPTION

The present disclosure describes apparatus such as camera modules that include folded optics using one or more meta optical elements (MOEs). A meta optical element (e.g., a metalens) has a metasurface (i.e., a surface with distributed small structures, such as meta-atoms, arranged to interact with light in a particular manner). For example, a metasurface can be a surface with a distributed array of nanostructures. The nanostructures may, individually or collectively, interact with light waves. For example, the nanostructures or other meta-atoms can be arranged to change a local amplitude, a local phase, or both, of an outgoing light wave.

Folded optics refers to an optical system in which a light beam (e.g., infrared or visible) is bent so as to make the optical path longer than a dimension (e.g., height) of the optical system. In accordance with the present disclosure, one or more MOEs are configured so that a chief ray of a light beam passing through the MOE(s) and focused on an image sensor of the camera module travels along a piece-wise linear path. That is, the chief (i.e., normal) ray travels along a path at least part of which is skewed (e.g., travels at an oblique angle) with respect to at least one metasurface of the MOE(s). Thus, the chief ray travels along a skewed path through the full stack (i.e., from the metasurface of a first MOE in the stack to the optically active surface of the image sensor).

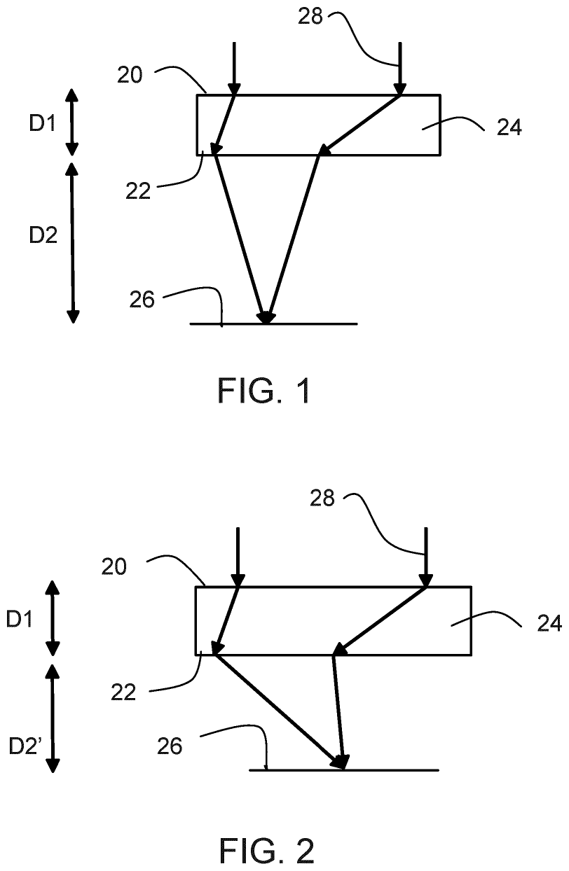

FIG. 1 illustrates an example of a camera module that includes a system of folded optics using first and second MOEs 20, 22. Light (e.g., infrared or visible) 28 impinging on the first MOE 20 passes through the first and second MOEs 20, 22 and is focused on an optically active surface of an image sensor 26 that is operable to detect the light signals impinging on its surface. The total track length (TTL) in this case is the sum of the distance D1 between the metasurfaces of the MOEs 20, 22 and the distance D2 from the metasurface of the second MOE 22 to the optically active surface of the image sensor. The image sensor 26 can be implemented, for example, as a CCD or SPAD sensor, and can be operable, for example, as a camera to capture digital image frames comprising image data, which can be used to reproduce and display digital images.

In the example of FIG. 1, the two MOEs 20, 22 are disposed, respectively, on opposite sides of a substrate 24 that is transparent or substantially transparent to a wavelength, or range of wavelengths, of interest (e.g., infrared or visible). The substrate 24 may be composed, for example, of glass, silicon, germanium, or a polymer. In some implementations, the MOEs 20 are circular, transmissive metalenses. In the example of FIG. 1, the first MOE 20 is asymmetric (e.g., not rotationally symmetric), which allows the incident beam 28 to propagate at an oblique angle through the substrate 24. The light 28 passes through both MOEs 20, 22, travels along a piece-wise linear path, and is focused on the optically active surface of the image sensor 26.

In some implementations, as shown in FIG. 2, the second MOE 22 also is asymmetric (e.g., not rotationally symmetric). Such an arrangement can allow the TTL (i.e., the sum of the distances D1+D2′) to be even shorter in some instances.

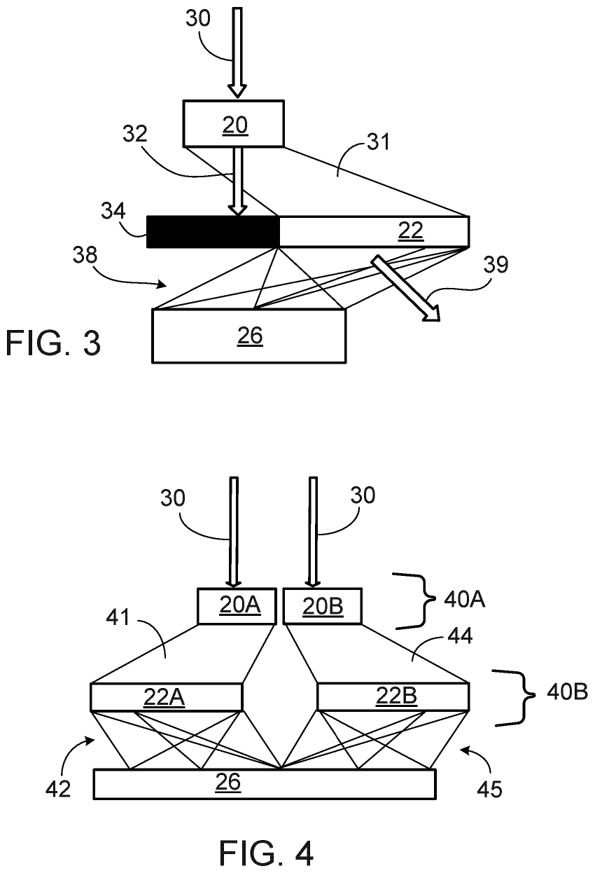

Allowing the incident light to evolve along a skewed path through the full stack also can facilitate blocking, or redirecting, certain diffractive orders of the light. That is, the metasurfaces of the MOEs 20, 22 can be configured such that the incident light is diffracted into multiple diffractive orders and such that, for example, the first (±1) diffractive orders are directed toward the optically active surface of the image sensor 26, whereas the 0^{th} and higher diffractive orders (i.e., ±2 and higher) either are blocked or directed away from the optically active surface of the image sensor 26. Maximizing the sensing efficiency, for example, for the first (±1) orders can help ensure increased light collection. FIG. 3 illustrates an example.

As shown in FIG. 3, a chief ray of light 30 is incident on the first MOE 20, which is configured such that light 32 of the 0^{th} diffractive order travels toward and is absorbed by light blocking material 34 (e.g., black epoxy or black chrome). Light 31 of the other diffractive orders travels toward the second MOE 22, which is configured such that light 38 of the ±1 diffractive orders is directed toward the optically active surface of the image sensor 26, whereas light 39 of the ±2 and higher diffractive order is directed away from the optically active surface of the image sensor 26. Thus, the configuration allows light of specified diffractive orders (e.g., ±1) to be directed toward and sensed by the image sensor 26, whereas light of other diffractive orders (e.g., 0^{th} order, and ±2 and higher orders) to be blocked or otherwise prevented from impinging on the optically active surface of the image sensor 26.

In the foregoing examples, the MOEs 20, 22 are disposed on opposite sides of the same substrate 24. In some implementations, however, the MOEs 20, 22 may be disposed on different substrates. Further, in some implementations, the space between the MOEs 20, 22 may simply be an air gap.

In the foregoing examples of FIGS. 1, 2 and 3, each lens level includes a single MOE. That is, the first lens level, which is further from the image sensor 26, includes one MOE 20. Likewise, the second lens level, which is closer to the image sensor 26, includes one MOE 22. In some implementations, however, one or both of the lens levels can include multiple MOEs. Such an arrangement can help achieve improved performance over a larger field of view (FOV). An example is illustrated in FIG. 4.

As shown in FIG. 4, the first lens level 40A includes multiple MOEs, 20A, 20B. Likewise, the second lens level 40B includes multiple MOEs 22A, 22B. The MOE 20A is configured to direct an incident chief ray of light toward the MOE 22A, which is configured to direct the light toward the optically active surface of the image sensor 26. Likewise, the MOE 20B is configured to direct an incident chief ray of light toward the MOE 22B, which is configured to direct the light toward the optically active surface of the image sensor 26. Thus, the multi-level lens configuration of MOEs is operable to skew incident light by an amount that depends, at least in port, on the angle of incidence.

An arrangement as in FIG. 4 can be advantageous for implementations in which different lens systems are disposed, for example, in front of the same array camera. The various lens systems can be optimized, for example, for different wavelengths (or ranges of wavelengths), or for different parts of the field of view.

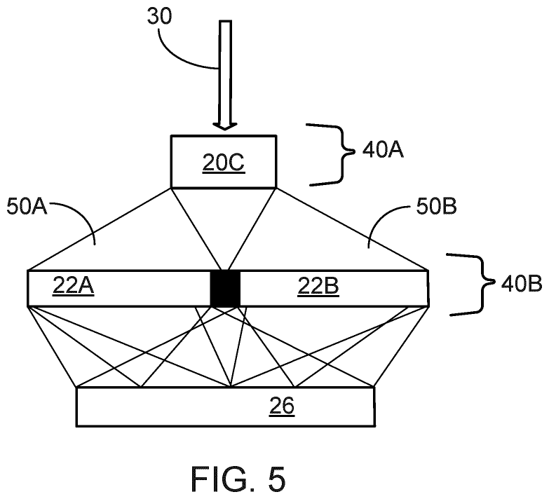

In some implementations, one of the lens levels may have multiple MOEs, whereas the other lens level may have only a single MOE. An example is illustrated in FIG. 5. As shown in FIG. 5, the first lens level 40A includes an MOE 20C, which is configured to skew light by an amount that depends, at least in part, on the polarization of the incident light. Light 50A having a first type of polarization is directed toward a first one of the MOEs 22A in the second lens level 40B, whereas light 50B having a second, different type of polarization is directed toward a second one of the MOEs 22B in the second lens level 40B. In some implementations, the MOE 20C in the first lens level 40A is configured so that each polarization type looks at half the field of view (FOV). The MOEs 22A, 22B in the second lens level 40B are configured to redirect the respective polarized light signals toward the optically active surface of the image sensor 26. By combining the two MOEs 20A, 20B in the first lens level of FIG. 4 into a single MOE 20C (FIG. 5) and distinguishing incident light based on its polarization, a smaller package for the module can be achieved in some cases.

The foregoing examples illustrate implementations in which a chief ray travels along a skewed path through a stack that includes two lens levels. In some implementations, the stack includes more than two lens levels, each of which includes at least one optical element having an optical metasurface. In these implementations as well, the MOEs are configured so that a chief ray of a light beam passing through the MOEs and focused on the image sensor of the camera module travels along a piece-wise linear path. That is, the chief (i.e., normal) ray travels along a path at least part of which is skewed (e.g., travels at an oblique angle) with respect to at least one metasurface of the MOEs. Thus, the chief ray travels along a skewed path through the full stack (i.e., from the metasurface of the outermost MOE to the surface of the image sensor).

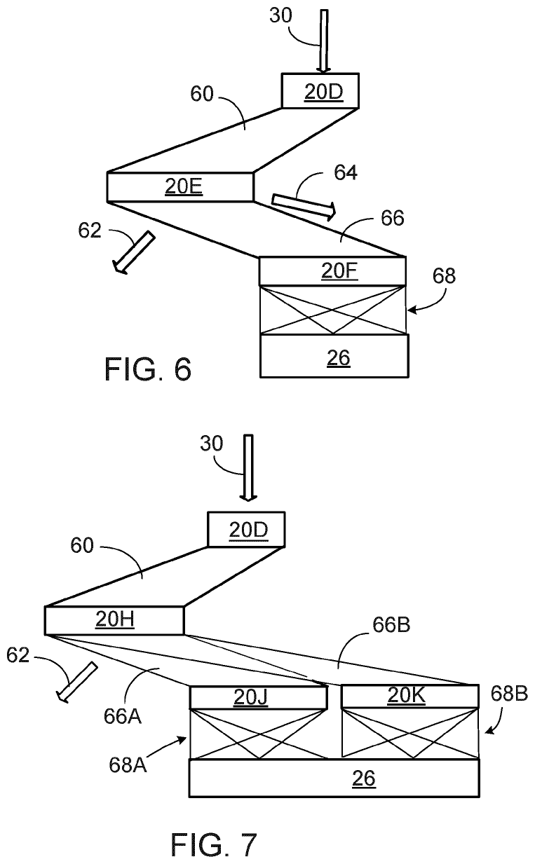

For example, FIG. 6 illustrates a camera module that includes a stack of three MOEs 20D, 20E, 20F. The MOEs are configured and arranged such that incident light 30 (e.g., a chief ray) passes through the first MOE 20D to the optically active surface of the image sensor 26 along a skewed path. After passing through the first MOE 20D, the light travels to the second MOE 20E, which is configured such that light 62 of the 0^{th} diffractive order and light 64 of the ±2 and higher diffractive orders is directed along one or more paths away from the optically active surface of the image sensor 26. On the other hand, light 66 of the ±1 diffractive orders travels along a path from the second MOE 22E to the third MOE 20F, which directs the light 68 to the optically active surface of the image sensor 26.

FIG. 7 illustrates another example a camera module that includes a stack of three lens levels. The MOEs are configured and arranged such that different diffractive orders of the light are handled differently and such that some of the incident light (e.g., a chief ray) 30 passes through the first MOE 20D to the optically active surface of the image sensor 26 along a skewed path. In the illustrated example, the first lens level includes a MOE 20D, the second lens level includes a MOE 20H, and the third lens level includes MOEs 20J, 20K. After passing through the first MOE 20D, the light travels to the second MOE 20H, which is configured such that light 62 of a particular diffractive order (e.g., the 0th diffractive order) is directed away from the optically active surface of the image sensor 26. On the other hand, a first portion of light 66A of the other diffractive orders is directed along a path from the second MOE 22H to a first MOE 20J in the third lens level, and a second portion of light 66B of the other diffractive orders is directed along a path from the second MOE 22H to a second MOE 20K in the third lens level. In some implementations, the first and second portions of light 66A, 66B may contain different diffractive orders of the light from one another. Each of the MOEs 20J, 20K in the third lens level directs respective light 68A, 68B to respective parts of the optically active surface of the image sensor 26.

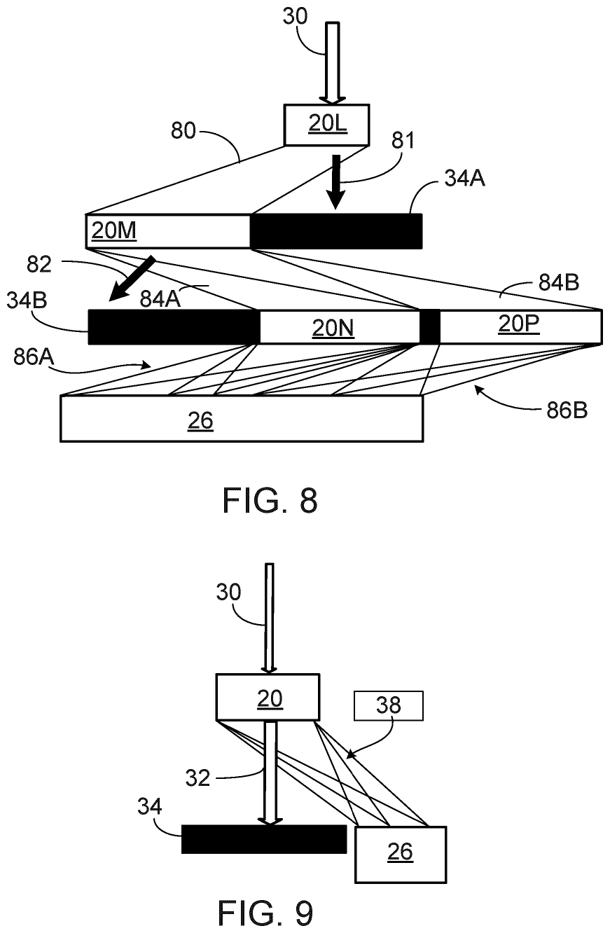

FIG. 8 illustrates another example a camera module that includes a stack of three lens levels. In this example as well, the MOEs are configured and arranged such that different diffractive orders of light are handled differently. Among other things, some of the diffractive orders of light can be blocked and prevented from impinging on the optically active surface of the image sensor 26.

In the illustrated example of FIG. 8, the first lens level includes a MOE 20L, the second lens level includes a MOE 20M, and the third lens level includes MOEs 20N, 20P. The MOEs are configured and arranged such that some of the incident light (e.g., a chief ray) 30 passes through the first MOE 20L to the optically active surface of the image sensor 26 along a skewed path. The first MOE 20L is configured such that light 81 of a particular diffractive order (e.g., the 0^{th} diffractive order) travels toward and is absorbed by light blocking material 34A. The remaining light 80 travels to the second MOE 20M, which is configured such that light 82 of a particular diffractive order (e.g., the 0th diffractive order) travels toward and is absorbed by light blocking material 34B. On the other hand, a first portion of light 84A of the other diffractive orders is directed along a path from the second MOE 22M to a first MOE 20N in the third lens level, and a second portion of light 84B of the other diffractive orders is directed along a path from the second MOE 22M to a second MOE 20P in the third lens level. In some implementations, the first and second portions of light 84A, 84B may contain different diffractive orders of the light from one another. Each of the MOEs 20N, 20P in the third lens level directs respective light 86A, 86B to respective parts of the optically active surface of the image sensor 26. Some implementations can include more than three MOEs in the stack through which the incident light (e.g., a chief ray) travels along a path to the optically active surface of the image sensor.

In some implementations, the folded optics includes only one optical element (e.g., a single MOE such as a metalens having a metasurface). FIG. 9 illustrates an example in which light 30 is incident on a MOE 20. As the light 30 passes through the MOE's metasurface, the MOE structure causes different diffractive orders of the light to be separated from one another so that different subsets of the diffractive orders travel in different directions. In particular, the skewing angle can, in some implementations, help reduce the overlap between the imaging diffractive order(s) (e.g., ±1) and other diffractive orders. Thus, in the example of FIG. 9, after the light 30 passes through the MOE's metasurface, some of the light (e.g., light of the ±1 diffractive orders) 38 travels toward the optically active surface of the image sensor 26 along a path at least part of which is skewed with respect to the metasurface of the MOE 20. Light 32 of other diffractive orders travels in one or more different directions. For example, some of the light 32 (e.g., light of the 0^{th} diffractive order) may travel toward light blocking or light absorbing material 34, or otherwise be directed along a path away from the optically active surface of the image sensor 26. In some instances, higher diffractive orders of the light (e.g., ±2 and higher) may disappear through total internal reflection in the MOE 20.

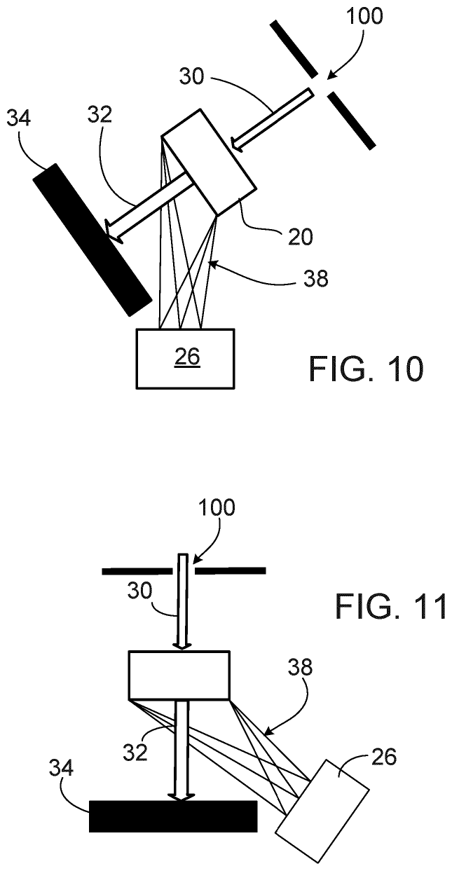

In some implementations, an optical axis of the one or more MOE(s) is rotated (e.g., tilted) with respect to the plane of the optically active surface of the image sensor. FIG. 9 illustrates one example; FIG. 10 illustrates another example. Such configurations can, in some cases, reduce the lens chief ray angle (i.e., the angle between the optical axis and the lens chief ray). The relative tilt can be helpful, in some instances, in getting more of the chief rays of light to impinge on the sensor 26 at an angle that is normal (or close to normal) to the sensor's optically active surface, which in turn can help increase the amplitude of the detected signal.

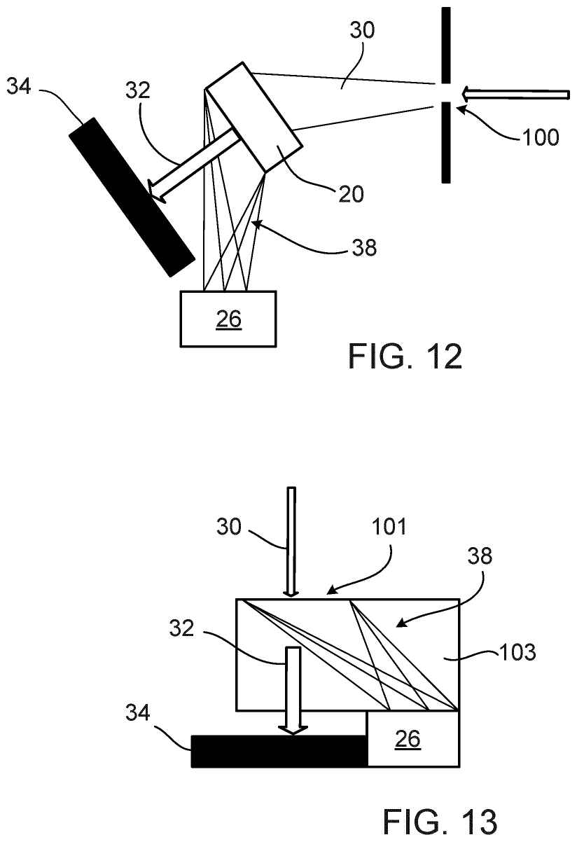

In some implementations, the camera modules include additional components For example, FIGS. 10, 11 and 12 illustrate examples in which the incident light passes through an aperture 100 before impinging on the folded optics, including the one or more MOEs 20. In the example of FIG. 12, the aperture 100 is tilted relative to the folded optics. Such an arrangement can, in some instances, help reduce the TTL. Some implementations may include additional or other optical components (e.g., a band pass filter).

In some implementations, after passing through the metasurface of the MOE 20, the light of the imaging diffractive order(s) propagates through air (see, e.g., FIG. 9). In some implementations, as shown in the example of FIG. 13, after passing through the metasurface 101 of the MOE, the light of the imaging diffractive order(s) propagates through a material 103 having a higher index of refraction than air. More generally, the optical system can be configured so that, after passing through the metasurface 101, the light of the imaging diffractive order(s) propagates through a material 103 having a higher index of refraction relative to the material of the metasurface 101. The transition to a higher index of refraction can be helpful, in some instances, to improve the modulation transfer function (MTF), improve resolution, and/or reduce optical aberration.

Depending on the implementation, any of the camera modules described above can be integrated, for example, into various compact electronic or other devices, including smartphones or other types of mobile devices such as tablets, laptop computers, game controllers, or other types of handheld computing devices.

Various modifications may be made to the foregoing examples. Accordingly, other implementations also are within the scope of the claims.

1. An apparatus comprising:
an image sensor having an optically active surface;
folded optics including at least one meta optical elements (MOE) configured such that a chief ray of light impinging on, and passing through, the at least one MOE, travels along a piece-wise linear path to the optically active surface of the image sensor.

2. The apparatus of claim 1 wherein the at least one MOE is configured such that the chief ray of light travels along a path at least part of which is skewed with respect to at least one metasurface of the at least one MOE.

3. The apparatus of claim 1, wherein the folded optics includes a plurality of MOEs configured such that the chief ray of light impinging on a first one of the MOEs passes through the plurality of MOEs and to the optically active surface of the image sensor along the piece-wise linear path.

4. The apparatus of claim 3 wherein the plurality of MOEs are configured such that the chief ray of light travels along a skewed path from a metasurface of the first one of the MOEs to the optically active surface of the image sensor.

5. The apparatus of claim 1, wherein the at least one MOE is configured such that the chief ray of light is focused on the optically active surface of the image sensor.

6. The apparatus of claim 3, wherein the plurality of MOEs includes at least three MOEs.

7. The apparatus of claim 1, wherein the at least one MOE is configured to cause at least one diffractive order of the light to travel in a direction such that the at least one diffractive order of the light does not reach the optically active surface of the image sensor.

8. The apparatus of claim 7 further including at least one light blocking material disposed so as to block or absorb the at least one diffractive order of the light.

9. The apparatus of claim 1, wherein the at least one MOE is configured such that only a subset of diffractive orders of the light reach the optically active surface of the image sensor.

10. The apparatus of claim 3, wherein the plurality of MOEs includes at least one MOE in a first lens level and at least two MOEs in a second lens level.

11. The apparatus of claim 10 wherein the second lens level is closer to the optically active surface of the image sensor than is the first lens level, and wherein the MOEs are arranged such that a first portion of light from the at least one MOE in the first lens level has a first subset of diffractive orders and passes through a first one of the MOEs in the second lens level, and a second portion of light from the at least one MOE in the first lens level has a second different subset of diffractive orders and passes through a second one of the MOEs in the second lens level.

12. The apparatus of claim 3, including first, second and third lens levels, wherein the plurality of MOEs are dispersed across the first, second and third lens levels, and wherein the MOEs are arranged such that the chief ray of light passes through the first MOE, then through at least one MOE in the second lens levels, and then through at least one MOE in the third lens levels.

13. The apparatus of claim 12 including at least two MOEs in the third lens level.

14. The apparatus of claim 13 wherein the third lens level is closer to the optically active surface of the image sensor than is the second lens level, and wherein the MOEs are arranged such that a first portion of light from the at least one MOE in the second lens level has a first subset of diffractive orders and passes through a first one of the MOEs in the third lens level, and a second portion of light from the at least one MOE in the second lens level has a second different subset of diffractive orders and passes through a second one of the MOEs in the third lens level.

15. The apparatus of claim 3, wherein at least one of the MOEs is asymmetric.

16. The apparatus of claim 1, wherein each of the at least one MOE is a metalens.

17. The apparatus of claim 1, wherein an optical axis of the at least one MOE is tilted with respect to a plane of the optically active surface of the image sensor.

18. The apparatus of claim 1, wherein the folded optics is configured such that, after passing through a metasurface of the at least one MOE, the light of an imaging diffractive order propagates through a material having a higher index of refraction relative to a material of the metasurface.
